(19) United States
(12) Patent Application Publication
(10) Pub. No.: US 2026/0015121 A1
(43) Pub. Date: Jan. 15, 2026

(54) TUBE-SHAPED CONTAINER

(71) Applicant: AI Bioelectronic Healthtech Co., Ltd., Taoyuan City (TW)

(72) Inventors: YEN-YI HO, Taoyuan City (TW); KENG-YUAN LI, Taoyuan City (TW)

(21) Appl. No.: 19/260,956

(22) Filed: Jul. 7, 2025

(30) Foreign Application Priority Data
Jul. 12, 2024 (TW) 113207543

(51) Int. Cl. B65D 1/00; B65D 25/20

(52) U.S. Cl. CPC B65D 1/00; B65D 25/20

(57) ABSTRACT

A tube-shaped container includes a tube body and a chipset. The tube body includes a tube body bottom and a bottom supporting part, wherein the bottom supporting part is integrally formed with the tube body bottom. The chipset is located on a side of the tube body bottom facing downward via an injection molding process.

### CROSS REFERENCE TO RELATED APPLICATIONS

This application claims priority of application No. 113207543 filed in Taiwan on Jul. 12, 2024 under 35 U.S.C. § 119, the entire contents of both of which are hereby incorporated by reference.

### BACKGROUND OF THE INVENTION

### 1. Field of the Invention

The present invention relates to a tube-shaped container, particularly to a tube-shaped container capable of preventing chips on the tube-shaped container from being damaged by external collisions.

### 2. Description of the Related Art

A test tube is a common laboratory utensil, consisting of a glass tube body that can accommodate the liquid to be tested. To endow the test tube with detection functionality, the manufacturer also installs a chip on the side wall of the glass tube body, so that the chip located on the side wall can detect data related to the test tube and its internal liquid.

However, the chip located on the side wall may be scratched due to collision with an external object (e.g., desktop, rack) during the movement of the test tube, causing the functionality of the chip to fail. Therefore, providing a new test tube that can prevent the chip on the test tube from being damaged by external collisions becomes an issue worth exploring.

### SUMMARY OF THE INVENTION

The object of the present invention is to provide a tube-shaped container with a chip on its surface that can prevent the chip from being damaged by external collisions.

To achieve the abovementioned object, a tube-shaped container of the present invention includes a tube body and a chipset. The tube body includes a tube body bottom and a bottom supporting part, wherein the bottom supporting part is integrally formed with the tube body bottom. The chipset is located on a side of the tube body bottom facing downward via an injection molding process.

According to one embodiment of the present invention, the bottom supporting part surrounds the chipset.

According to one embodiment of the present invention, the chipset further includes a blockchain information tracking part, and the blockchain information tracking part is electrically connected to a blockchain network.

According to one embodiment of the present invention, the chipset further includes a positioning part for positioning the tube-shaped container.

According to one embodiment of the present invention, the chipset further includes a temperature detector for detecting a temperature of the tube-shaped container.

According to one embodiment of the present invention, the chipset further includes an RFID tag, and the RFID tag records the information of the tube-shaped container via a radio frequency identification method.

According to one embodiment of the present invention, the chipset further includes a wireless module, and the wireless module is electrically connected to an external computer.

According to one embodiment of the present invention, the chipset further includes a battery, and the battery is used for providing power.

According to one embodiment of the present invention, the tube body is made of biodegradable plastic.

According to one embodiment of the present invention, the positioning part is a Global Positioning System (GPS) chip.

### BRIEF DESCRIPTION OF THE DRAWINGS

FIG. 1 is a schematic view of the tube-shaped container of one embodiment of the present invention.

FIG. 2 is a cross-sectional view of the tube-shaped container of one embodiment of the present invention.

FIG. 3 is a system architecture diagram of the tube-shaped container of one embodiment of the present invention.

### DETAILED DESCRIPTION OF THE PREFERRED EMBODIMENT

To provide a clearer understanding of the technical content of the present invention, a preferred embodiment is described below.

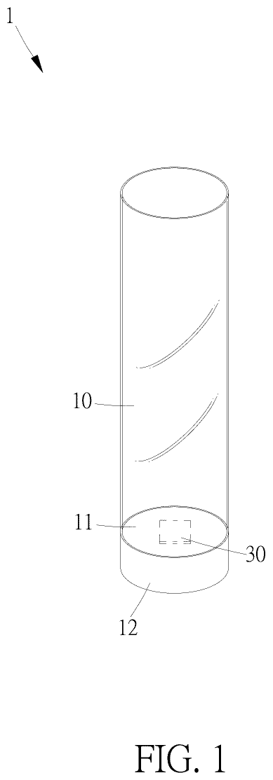

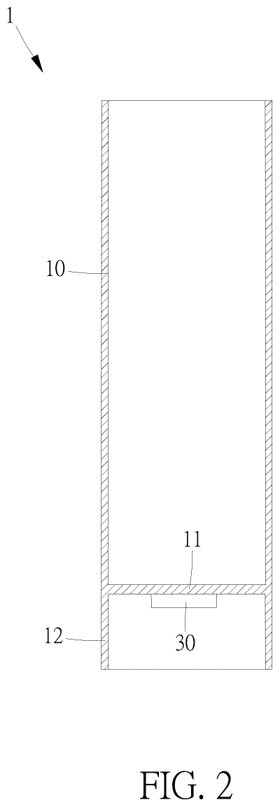

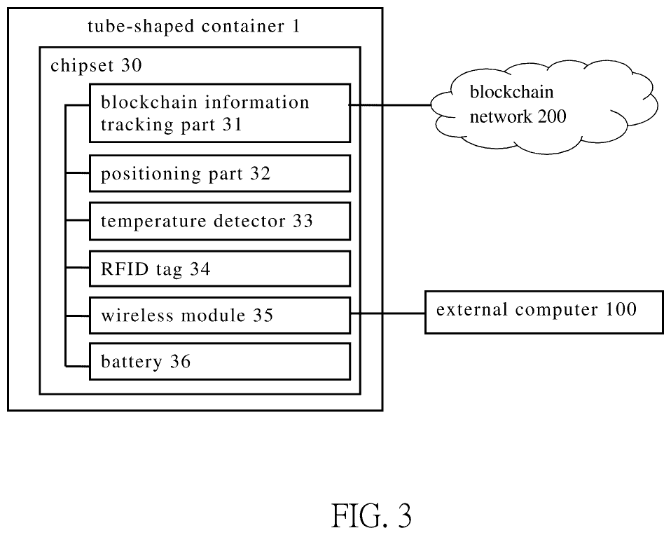

Please refer to FIG. 1 to FIG. 3 about the tube-shaped container in one embodiment of the present invention. FIG. 1 is a schematic view of the tube-shaped container of one embodiment of the present invention. FIG. 2 is a cross-sectional view of the tube-shaped container of one embodiment of the present invention. FIG. 3 is a system architecture diagram of the tube-shaped container of one embodiment of the present invention.

As shown in FIG. 1 to FIG. 3, in one embodiment of the present invention, the tube-shaped container 1, such as a test tube, a freezing tube, a centrifuge tube, etc., is a tube-shaped device used for containing a liquid and being electrically connected to a blockchain network 200, and the tube-shaped container 1 can prevent damage to the chipset on the tube-shaped container 1 from external collisions. The tube-shaped container 1 can be electrically connected to an external computer 100, to transmit related information of the tube-shaped container 1 and the contained liquid to the external computer 100. The tube-shaped container 1 includes a tube body 10 and a chipset 30.

In one embodiment of the present invention, the tube body 10 is used for containing the liquid. The tube body 10 is made of biodegradable plastic. The biodegradable plastic is composed of materials that can be decomposed by microorganisms, such as starch, polylactic acid, and fibrous proteins, and therefore the tube body 10 of the present invention can be decomposed by microorganisms, making it environmentally friendly. However, the material of the tube body 10 is not limited to the abovementioned description, and it can also be polypropylene (PP), polyamide (PA), or polycarbonate (PC).

In one embodiment of the present invention, the tube body 10 includes a tube body bottom 11 and a bottom supporting part 12. The tube body bottom 11 is the bottom of the tube body 10. The bottom supporting part 12 is an annular structure which is integrally formed with the outer circumference of the tube body bottom 11. The bottom supporting part 12 can enable the tube body 10 to stand on a plane (e.g., a desktop), and the bottom supporting part 12 can prevent the tube body bottom 11 from directly colliding with external objects, thereby preventing the tube body bottom 11 from breaking. However, the shape of the bottom supporting part 12 is not limited to an annular structure; it can also be other shapes with closed perimeters, such as square frames or hexagonal frames.

In one embodiment of the present invention, the chipset 30 is located on a side of the tube body bottom 11 facing downward via an injection molding process, and the bottom supporting part 12 surrounds the chipset 30. As a result, the chipset 30 located on the tube body bottom 11 can remain suspended without touching the desktop, and the bottom supporting part 12 around the chipset 30 can protect the chipset 30 from being damaged by colliding with external objects, thereby ensuring that the chipset 30 is not damaged during use and transportation, thereby extending its service life. Additionally, via using the injection molding process, the tube-shaped containers 1 can be efficiently mass-produced, and excess production materials can also be recycled and reused, achieving the effect of cost savings.

In one embodiment of the present invention, the chipset 30 includes a blockchain information tracking part 31, a positioning part 32, a temperature detector 33, an RFID tag 34, a wireless module 35, and a battery 36. The blockchain information tracking part 31 is a computing chip that is electrically connected to a blockchain network 200. The blockchain information tracking part 31 records the source and history of the liquid in the blockchain network 200, utilizing the characteristics of blockchain being traceable and difficult to tamper with, to record and track the circulation history of the tube-shaped container 1. According to one embodiment of the present invention, the source of the liquid is, for example, blood or urine obtained during a health check-up by a subject; the circulation history includes the location of the health check-up, the medical institution conducting the health check-up, the process of storing the tube-shaped container 1, and the process of transporting the tube-shaped container 1, etc.; furthermore, the circulation history of the tube-shaped container 1 can also be input into the blockchain information tracking part 31 by the external computer 100, and then recorded in the blockchain network 200 by the blockchain information tracking part 31. In this way, utilizing the characteristics of blockchain being traceable and difficult to tamper with, the source and circulation history of the liquid in the tube-shaped container 1 can be clearly recorded and managed.

The positioning part 32 is a global positioning system (GPS) chip, and the positioning part 32 is used for positioning the tube-shaped container 1 to determine the current location of the tube-shaped container 1. The temperature detector 33 is a chip with temperature sensing functionality, used for detecting the temperature of tube-shaped container 1, thereby allowing the monitoring of whether the tube-shaped container 1 is at an appropriate temperature to prevent liquid degradation due to overheating. The RFID tag 34 records information about the tube-shaped container 1 via radio frequency identification (RFID) method, the information is, for example, the capacity of tube-shaped container 1, the usage period of tube body 10, the identity of the examiner and the inspection date and location of the liquid inside tube-shaped container 1, etc.; the information recorded by the RFID tag 34 can be input via the external computer 100. However, the information of the tube-shaped container 1 is not limited to the above, and can be changed according to design requirements.

In one embodiment of the present invention, the wireless module 35, for example, is a network chip, and the wireless module 35 is electrically connected to the external computer 100. The wireless module 35 is used for transmitting the information detected by the chipset 30 to the external computer 100, so that the medical personnel operating the external computer 100 can understand the data of the liquid contained in the tube-shaped container 1, such as the source of the liquid, the history, and the properties of the liquid. The battery 36 is used for providing power to the chipset 30 to ensure that the chipset 30, which requires power, can operate normally.

As shown in FIG. 1 to FIG. 3, the tube-shaped container 1 of the present invention, in practical use (e.g., during health check-ups), can accommodate the liquid to be tested (e.g., the blood of the subject under examination). The liquid extracted from the subject under examination, such as blood, will flow into the tube body 10.

Additionally, the positioning part 32 will position the tube-shaped container 1, to determine the current position of the tube-shaped container 1, to prevent the tube-shaped container 1 from being lost. The temperature detector 33 is a chip with temperature sensing functionality used for detecting the temperature of the tube-shaped container 1, thereby allowing the monitoring of whether the tube-shaped container 1 is at an appropriate temperature to avoid the quality of the liquid being affected by a hot environment.

Additionally, the medical personnel can also operate an external computer 100 to access to the wireless module 35 of the tube-shaped container 1 to input information into the RFID tag 34, such as the capacity of the tube-shaped container 1, the shelf life of the tube body 10, the identity of the subject and the inspection date and location of the liquid inside the tube-shaped container 1, etc.; thereby, in the future, the medical personnel can use a wireless RFID reader to read the data recorded in the RFID tag 34, to quickly understand the relevant information of the tube-shaped container 1 and the liquid.

Additionally, the medical personnel can also operate the external computer 100 to input the item circulation information into the blockchain information tracking part 31, and then record the item circulation information in the blockchain network 200 through the blockchain information tracking part 31. Via the function of tracing item circulation through the blockchain, the identity of the person undergoing the test, the location of the health check, the medical institution responsible for the health check, the storage and transportation process of the tube-shaped container 1, etc., can all be recorded in the blockchain network 200. In this way, one can take advantage of the characteristics of the blockchain, which are traceable and difficult to tamper with, to clearly record and manage the source of the liquid in the tube-shaped container 1 and its subsequent circulation history. Thus, the medical personnel can also quickly trace the identity of the person undergoing the test and the source of the liquid through the function of tracing item circulation via the blockchain.

Additionally, during the process of storing the tube-shaped container 1 and transporting tube-shaped container 1, the chipset 30 located on the tube body bottom 11 can hang in the air without touching the desk, and the bottom supporting part 12 around the chipset 30 can protect the chipset 30 from being damaged by external objects, thereby ensuring that the chipset 30 is not damaged by external objects (such as walls, desks, and shelving) during the process of storing tube-shaped container 1 and transporting tube-shaped container 1, thereby extending its service life.

Via the design of the tube-shaped container 1 of the present invention, the tube-shaped container 1 can have diverse and convenient functions, such as tracing the source and history of liquids, positioning the tube-shaped container 1 to determine its current location, detecting the temperature of the tube-shaped container 1 to monitor whether it is at an appropriate temperature, and recording data wirelessly using radio frequency identification (RFID) for healthcare professionals to quickly read the data. Additionally, the tube body of the tube-shaped container 1 is made of biodegradable plastic, which can be decomposed by microorganisms in the natural environment, thereby having an environmentally friendly effect. Furthermore, the chipset can be suspended, and the bottom supporting part around the chipset can protect the chipset from being damaged by collisions with external objects, ensuring that the chipset is not damaged by external objects during the preservation and transportation of the tube-shaped container, thereby extending its service life.

It should be noted that the above is merely an embodiment and not limited to that embodiment. For example, if it does not deviate from the basic structure of the present invention, it shall be within the scope of the claims of the present patent, and the scope of the patent application shall prevail.

What is claimed is:

1. A tube-shaped container, comprising:
a tube body, comprising a tube body bottom and a bottom supporting part, wherein the bottom supporting part is integrally formed with the tube body bottom;
a chipset, located on a side of the tube body bottom facing downward via an injection molding process.

2. The tube-shaped container as claimed in claim 1, wherein the bottom supporting part surrounds the chipset.

3. The tube-shaped container as claimed in claim 2, wherein the chipset further comprises a blockchain information tracking part, and the blockchain information tracking part is electrically connected to a blockchain network.

4. The tube-shaped container as claimed in claim 3, wherein the chipset further comprises a positioning part for positioning the tube-shaped container.

5. The tube-shaped container as claimed in claim 4, wherein the chipset further comprises a temperature detector for detecting a temperature of the tube-shaped container.

6. The tube-shaped container as claimed in claim 5, wherein the chipset further comprises an RFID tag, and the RFID tag records an information of the tube-shaped container via a radio frequency identification method.

7. The tube-shaped container as claimed in claim 6, wherein the chipset further comprises a wireless module, and the wireless module is electrically connected to an external computer.

8. The tube-shaped container as claimed in claim 7, wherein the chipset comprises a battery, and the battery is used for providing power.

9. The tube-shaped container as claimed in claim 8, wherein the tube body is made of biodegradable plastic.

10. The tube-shaped container as claimed in claim 9, wherein the positioning part is a Global Positioning System (GPS) chip.
